(19) United States
(12) Patent Application Publication
(10) Pub. No.: US 2025/0316275 A1
(43) Pub. Date: Oct. 9, 2025

(54) Systems And Methods Of Combining RTC And CDN For Robust Audio Transmission

(71) Applicant: Agora Lab, Inc., Santa Clara, CA (US)

(72) Inventors: Yi Lv, Shanghai (CN); Sen Li, Shanghai (CN); Qiankun Li, Shanghai (CN); Ruofei Chen, Shanghai (CN)

(21) Appl. No.: 18/630,115

(22) Filed: Apr. 9, 2024

(51) Int. Cl. G10L 19/005

(52) U.S. Cl. CPC G10L 19/005

(57) ABSTRACT

A method of audio transmission of a voice segment of a speaker is disclosed. The method includes obtaining, via an encoder, the voice segment of the speaker. The method also includes obtaining, from one or more servers in communication with the encoder, a reference sample associated with the voice segment of the speaker. The method further includes establishing a timestamp associated with the voice segment of the speaker relative to the reference sample and encoding, via the encoder, an audio packet that includes the voice segment of the speaker and the timestamp associated with the voice segment of the speaker. The method also includes transmitting, in real-time, the audio packet to a decoder, wherein the voice segment of the speaker is to be combined with the reference sample based on the timestamp associated with the voice segment of the speaker during decoding.

### TECHNICAL FIELD

This disclosure relates to audio processing, and in particular, to optimizing audio transmission.

### BACKGROUND

Communication may frequently occur online over various communication channels and via many media types. By way of example, such an interaction may be real-time communication (RTC) using audio and/or video conferencing or streaming or, in some circumstances, simple telephone voice calls. The audio and/or video communication may be or may include speech, voice (e.g., singing represented as a voice segment), visual content, or a combination thereof. Such RTC may include one or more users (i.e., one or more sending users) that may transmit (e.g., the audio and/or the video) to one or more receiving users. For example, a concert may be live streamed to many viewers. In another example, a sending user may sing a song (e.g., karaoke) that may be live-streamed to viewers, whereby the live-stream may include both the singing voice of the sending user and the underlying music thereof.

In RTC, some users may wish to improve the audio quality being transmitted. For example, users may wish to decrease or eliminate buffering, sound packet loss, jitter, or a combination thereof caused by unstable network conditions.

### SUMMARY

In one aspect, a method of audio transmission of a voice segment of a speaker is disclosed. The method includes receiving, via an encoder, the voice segment of the speaker. The method also includes obtaining, from one or more servers in communication with the encoder, a reference sample associated with the voice segment of the speaker. The method further includes establishing a timestamp associated with the voice segment of the speaker relative to the reference sample and encoding, via the encoder, an audio packet that includes the voice segment of the speaker and the timestamp associated with the voice segment of the speaker. The method also includes transmitting, in real-time, the audio packet to a decoder, wherein the voice segment of the speaker in the audio packet is to be combined with the reference sample based on the timestamp associated with the voice segment of the speaker during decoding.

In another aspect, a non-transitory computer-readable storage medium configured to store computer programs for audio transmission of a voice segment of a speaker is disclosed. The computer programs include instructions executable by at least one processor. The instructions executable by the at least one processor include instructions to receive, via an encoder, the voice segment of the speaker. The instructions executable by the processor include instructions to obtain, from one or more servers in communication with the encoder, a reference sample associated with the voice segment of the speaker. The instructions executable by the at least one processor include instructions to establish a timestamp associated with the voice segment of the speaker relative to the reference sample and encode, via the encoder, an audio packet that includes the voice segment of the speaker and the timestamp associated with the voice segment of the speaker. The instructions executable by the at least one processor include instructions to transmit, in real-time, the audio packet to a decoder, wherein the voice segment of the speaker in the audio packet is to be combined with the reference sample based on the timestamp associated with the voice segment of the speaker during decoding.

In another aspect, a method of audio transmission of a voice segment of a speaker is disclosed. The method includes, obtaining, from one or more servers via a content delivery network, a reference sample associated with the voice segment. The method also includes receiving, from an encoder via real-time, an audio packet that includes the voice segment of the speaker and a timestamp associated with the voice segment of the speaker relative to the reference sample. Additionally, responsive to receiving the audio packet from the encoder, the method includes combining the voice segment of the speaker with the reference sample based upon the timestamp associated with the voice segment of the speaker.

### BRIEF DESCRIPTION OF THE DRAWINGS

The disclosure is best understood from the following detailed description when read in conjunction with the accompanying drawings. It is emphasized that, according to common practice, the various features of the drawings are not to scale. On the contrary, the dimensions of the various features are arbitrarily expanded or reduced for clarity.

FIG. 1 is a diagram of an example of a system for media transmission.

FIG. 2 is a diagram of an example of a real-time audio communications system.

FIG. 3 is a diagram of an example of a real-time audio communications system for audio recordings.

FIG. 4 is a diagram of another example of a real-time audio communications system for audio recordings.

FIG. 5 is a flowchart of an example of a technique for real-time audio communication.

FIG. 6 is a flowchart of an example of a technique for real-time audio communication.

### DETAILED DESCRIPTION

An audio communication system may include a sender (i.e., a sending device) and a receiver (i.e., a receiving device). The sender may perform at least some of the steps of audio capturing, audio conversion (e.g., converting an analog audio signal into a digital format), audio encoding, and audio transmission. For example, the sender may be a client device that captures and transmits (e.g., streams) audio in real-time to one or more receivers. In another example, the sender may be a streaming server, which may real-time audio or pre-recorded audio to be streamed to one or more receivers. The receivers may thus perform the steps of audio decoding, audio decompression, audio conversion (e.g., converting the digital format into the original analog audio signal), and audio transmission to one or more playback devices (e.g., headphones, speakers, etc.) Thus, based on the above, the sender may be or may contain an encoder and the receiver may be or may contain a decoder. Additionally, the sender and receiver may communicate over a network. That is, the encoded audio data may be transmitted from the sender to the receiver over the network. For example, the audio data may be transmitted from the sender to the receiver via multiple servers of the network.

The audio captured may be any type of sound waves captured by the sender (e.g., a microphone of the sender). By way of example, the audio captured may be a voice (e.g., a voice segment) of a user of the sender. The voice (e.g., voice segment) captured may be talking by the user and/or singing by the user. However, the teachings herein are not limited to only capturing a voice of a user. For example, the audio captured or otherwise obtained by the sender may be live stream audio data or pre-recorded audio data, such as a music file, an audiobook, a presentation, the like, or a combination thereof. Additionally, it should be noted that while audio communication is described herein, video communication is also contemplated. That is, the audio transmitted from the sender to the receiver may be transmitted in conjunction with video data (e.g., a video conference and/or video stream that may include an audio component).

Different techniques are known for encoding and decoding audio. For example, audio data may be encoded/decoded using analog-to-digital conversion (ADC), in which continuous analog audio signals may be converted into discrete digital samples. In such an encoding/decoding, snapshots of the continuous analog audio signals may be taken at regular intervals and assigned digital values, whereby the converted digital audio data may then be converted back to the continuous analog signal for audio playback by the receiver. Additionally, audio data may be compressed using one or more compression algorithms (e.g., lossless and/or lossy compression, such as Free Lossless Audio Codec (FLAC), MP3, etc.), whereby the compressed audio data may be decompressed by the receiver for audio playback. Additionally, when audio data is transmitted in a digital format, the digital audio data may be divided into segments (e.g., packets) for transmission over a network. In such a case, each packet may contain a portion of the audio data along with additional information for synchronization and/or error correction (e.g., correction to avoid packet loss, jitter, etc.).

Conventionally, the above techniques for audio transmission may be conventionally used to encode, transmit, and decode audio data in real-time communication (RTC) over a network. For example, for live-stream karaoke applications, a singer may sing into a microphone of a device (i.e., the sender) so that the device may capture the singing as audio data, encode the audio data, transmit the audio data to an audience (e.g., one or more users of receivers), and playback the audio data so that the audience may listen, in real-time, to the singing of the singer. In such a scenario, the audio data transmitted to the audience may also include music associated with the singing so that, when the audio data is played back for the audience at the receivers, the playback includes both the singing and the associated music.

However, based on the above scenario, in RTC applications, network conditions may significantly impact the quality of audio playback at the receivers. For example, transmitting (e.g., streaming) and receiving the entirety of both the singing of the singer and the associated music may consume a significant amount of bandwidth. Additionally, real-world network conditions may vary, whereby such variance may result in audio packet loss, jitter (e.g., jitter caused by a freeze in communication during RTC transmission), other audio data degradation, or a combination thereof. Similarly, conventional packet loss concealment (PLC) algorithms employed by the receiver to resolve some of the above issues may generally be adapted for speech audio data and not singing/music audio data, whereby the speech audio data may consume significantly less bandwidth and thus result in lower packet loss and/or smaller jitter.

Implementations according to this disclosure can reduce the network bandwidth consumption of a network and the processing power consumption of the receiving and sending device in addition to improving the listening experience at the receiver. Audio transmission may be performed in a manner that separates the singing audio data from the associated music audio data. As a result, the singing audio data may be transmitted from the sender to the receiver via RTC transmission while the associated music audio data may be transmitted or otherwise accessed by the receiver in a manner other than RTC transmission. As a result, the strain on the network bandwidth may be significantly decreased, thereby decreasing packet loss and/or jitter which may be caused by fluctuating network conditions. Therefore, the resultant listening experience at the receiver may be significantly improved by providing better quality audio output. It should also be noted that the implementations according to this disclosure may be used in any type of audio transmission and are not particularly limited to singing/music audio data.

To describe some implementations in greater detail, reference is first made to examples of hardware and software structures used to implement a real-time audio communication system. It should be noted that the teachings herein are not limited to real-time audio communication systems and the real-time audio communication systems described herein are intended for illustrative purposes only due to their typical strain on network bandwidth consumption of a network. As such, the teachings herein may be implemented with any audio and/or video communication system.

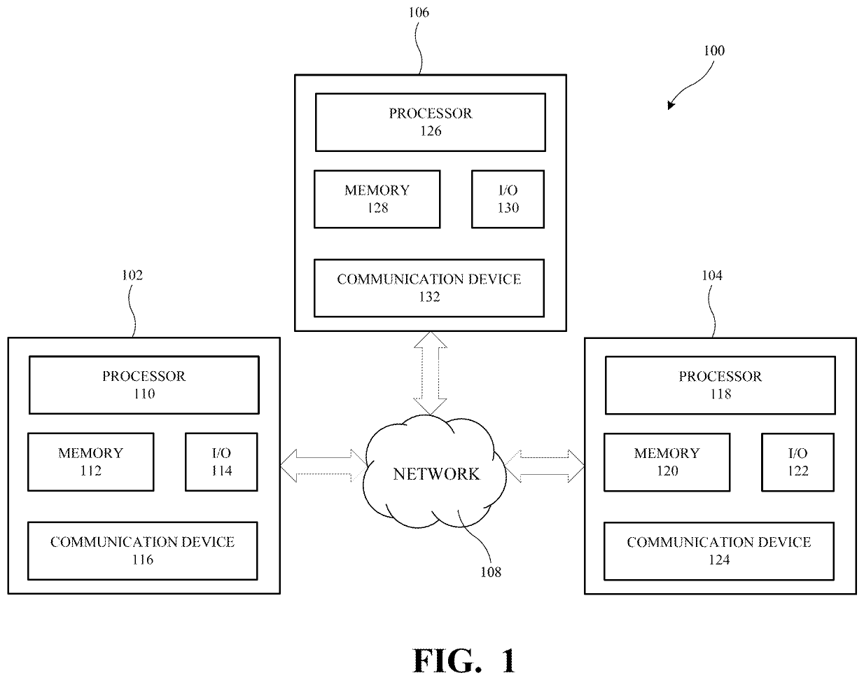

FIG. 1 is a diagram of an example of a system 100 for media transmission, including the transmission of real-time wide-angle audio data. As shown in FIG. 1, the system 100 may include multiple apparatuses and networks, such an apparatus 102, an apparatus 104, an apparatus 106, and a network 108.

The apparatuses may be implemented by any configuration of one or more computers, such as a microcomputer, a mainframe computer, a supercomputer, a general-purpose computer, a special-purpose/dedicated computer, an integrated computer, a database computer, a remote server computer, a personal computer, a laptop computer, a tablet computer, a cell phone, a personal data assistant (PDA), a wearable computing device, or a computing service provided by a computing service provider (e.g., a web host or a cloud service provider). In some implementations, an apparatus may be implemented in the form of multiple groups of computers that are at different geographic locations and may communicate with one another, such as by way of a network. While certain operations may be shared by multiple computers, in some implementations, different computers may be assigned to different operations. In some implementations, the system 100 may be implemented using general-purpose computers/processors with a computer program that, when executed, carries out any of the respective techniques, algorithms, and/or instructions described herein. In addition, or alternatively, for example, special-purpose computers/processors including specialized hardware may be utilized for carrying out any of the methods, algorithms, or instructions described herein.

The apparatus 102 may have an internal configuration of hardware including a processor 110 and a memory 112. The processor 110 may be any type of device or devices capable of manipulating or processing information. In some implementations, the processor 110 may include a central processor (e.g., a central processing unit or CPU). In some implementations, the processor 110 may include a graphics processor (e.g., a graphics processing unit or GPU). Although the examples herein may be practiced with a single processor as shown, advantages in speed and efficiency may be achieved using more than one processor. For example, the processor 110 may be distributed across multiple machines or devices (each machine or device having one or more processors) that may be coupled directly or connected via a network (e.g., a local area network).

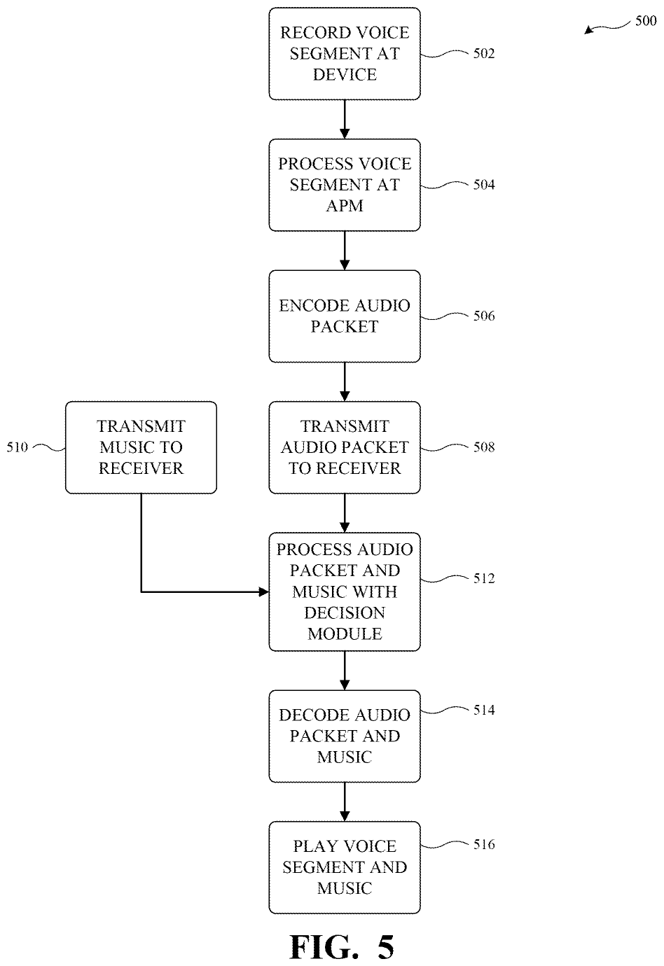

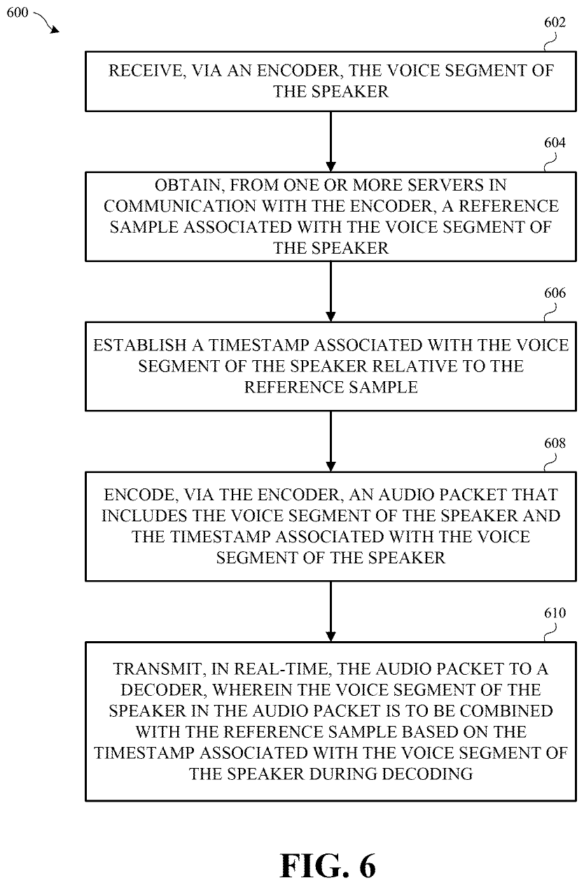

The memory 112 may include any transitory or non-transitory device or devices capable of storing codes (e.g., instructions) and data that may be accessed by the processor (e.g., via a bus). The memory 112 may be a random-access memory (RAM) device, a read-only memory (ROM) device, an optical/magnetic disc, a hard drive, a solid-state drive, a flash drive, a security digital (SD) card, a memory stick, a compact flash (CF) card, or any combination of any suitable type of storage device. In some implementations, the memory 112 may be distributed across multiple machines or devices, such as in the case of a network-based memory or cloud-based memory. The memory 112 may include data (not shown), an operating system (not shown), and one or more applications (not shown). The data may include any data for processing (e.g., an audio stream, a wide-angle video stream, or a multimedia stream). At least one of the applications may include programs that permit the processor 110 to implement instructions to generate control signals for performing functions of the techniques in the following description. For example, when functioning as a sender and/or a receiver, the applications may include instructions for performing at least the techniques described with respect to FIGS. 5 and 6.

In some implementations, in addition to the processor 110 and the memory 112, the apparatus 102 may also include a secondary (e.g., external) storage device (not shown). The secondary storage device may be a storage device in the form of any suitable non-transitory computer-readable medium, such as a memory card, a hard disk drive, a solid-state drive, a flash drive, or an optical drive. Further, the secondary storage device may be a component of the apparatus 102 or may be a shared device accessible via a network. In some implementations, the application in the memory 112 may be stored in whole or in part in the secondary storage device and loaded into the memory 112 as needed for processing.

The apparatus 102 may include input/output (I/O) devices. For example, the apparatus 102 may include an I/O device 114. The I/O device 114 may be implemented in various ways, for example, it may be a display that can be coupled to the apparatus 102 and configured to display a rendering of graphics data. The I/O device 114 may be any device capable of transmitting a visual, acoustic, or tactile signal to a user, such as a display, a touch-sensitive device (e.g., a touchscreen), a speaker, an earphone, a light-emitting diode (LED) indicator, or a vibration motor. The I/O device 114 may also be any type of input device either requiring or not requiring user intervention, such as a keyboard, a numerical keypad, a mouse, a trackball, a microphone, a touch-sensitive device (e.g., a touchscreen), a sensor, or a gesture-sensitive input device.

The I/O device 114 may alternatively or additionally be formed of a communication device for transmitting signals and/or data. For example, the I/O device 114 may include a wired means for transmitting signals (e.g., audio signals) or data (e.g., audio data) from the apparatus 102 to another device. For another example, the I/O device 114 may include a wireless transmitter or receiver using a protocol compatible to transmit signals from the apparatus 102 to another device or to receive signals from another device to the apparatus 102.

The apparatus 102 may include a communication device 116 to communicate with another device. The communication may be via the network 108. The network 108 may be one or more communications networks of any suitable type in any combination, including, but not limited to, networks using Bluetooth communications, infrared communications, near field connections (NFCs), wireless networks, wired networks, local area networks (LANs), wide area networks (WANs), virtual private networks (VPNs), cellular data networks, or the Internet. The communication device 116 may be implemented in various ways, such as via a transponder/transceiver device, a modem, a router, a gateway, a circuit, a chip, a wired network adapter, a wireless network adapter, a Bluetooth adapter, an infrared adapter, an NFC adapter, a cellular network chip, or any suitable type of device in any combination that is coupled to the apparatus 102 to provide functions of communication with the network 108.

Similar to the apparatus 102, the apparatus 104 may include a processor 118, a memory 120, an I/O device 122, and a communication device 124. The implementations of elements 118-124 of the apparatus 104 may be similar to the corresponding elements 110-116 of the apparatus 102. Additionally, the apparatus 106 may include a processor 126, a memory 128, an I/O device 130, and a communication device 132. The implementations of elements 126-132 of the apparatus 106 may be similar to the corresponding elements 110-116 of the apparatus 102 and the corresponding elements 118-124 of the apparatus 104.

Each of the apparatus 102, the apparatus 104, and the apparatus 106 may be, such as at different times of a real-time communication session, a receiving device (i.e., a receiver) or a sending device (i.e., a sender). A receiver may perform decoding operations, such as of audio streams as described herein. As such, the receiver may also be referred to as a decoding apparatus or device and may include or be a decoder. A sender may also be referred to as an as an encoding apparatus or device and may include or be an encoder. The apparatus 102, the apparatus 104, and the apparatus 106 may communicate with one another via the network 108.

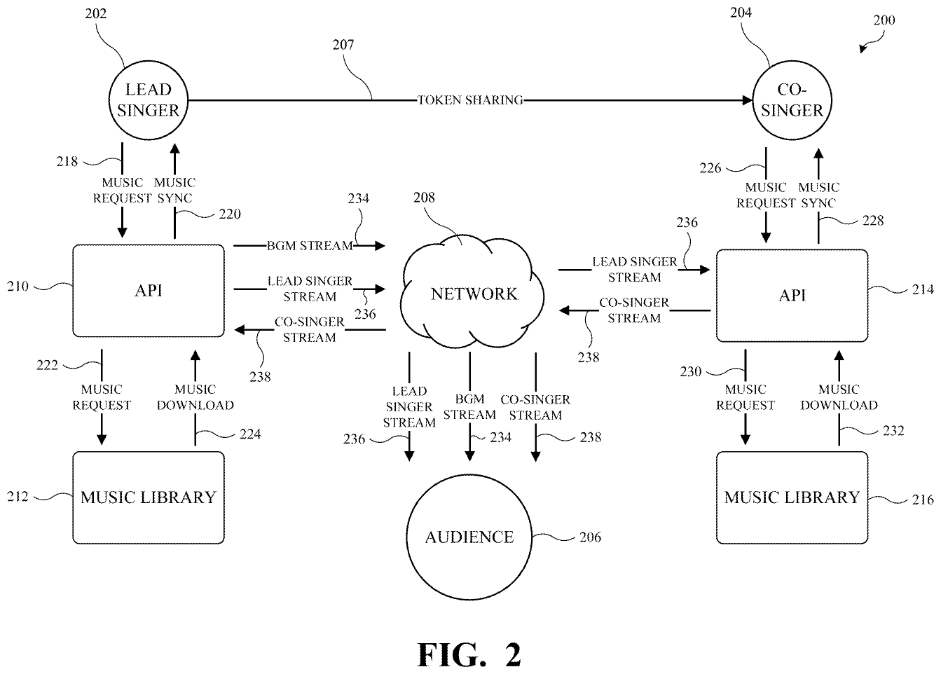

FIG. 2 is a diagram of an example of a real-time audio communications system 200. In particular, the example shown in FIG. 2 illustrates a real-time audio communication system for “Karaoke Television” (KTV). However, such a system may be implemented for other means of real-time audio communication.

As shown in FIG. 2, the system 200 may include multiple singers and multiple audiences in communication over various networks. For example, the system 200 may include a lead singer 202, a co-singer 204, and an audience 206 in communication via a network 208. For illustrative purposes, the lead singer 202 may use or may be part of the apparatus 102, the co-singer may use or may be part of the apparatus 104, and the audience may use or may be a part of the apparatus 106. Based on the above arrangement, the lead singer 202 and the co-singer 204 may, in real-time, sing along to pre-recorded music. For example, the lead singer 202 and the co-singer 204 may be sing along with the pre-recorded music as prompted by lyrics displayed on a display screen of the apparatus 102 and the apparatus 104, respectively. The singing and the pre-recorded music may then, in real-time be transmitted to the audience 206 for listening and/or watching, such as via I/O device 130 of the apparatus 106 (e.g., a speaker and/or display screen).

To facilitate such real-time streaming, the lead singer 202 (e.g., the apparatus 102) may be in communication with, or may execute an application programming interface (API) 210 to coordinate singing of the lead singer 202 with music stored in a music library 212. For example, the apparatus 102 may include the API 210, whereby the API 210 may include a set of rules or protocols that may be stored in the memory 112 and executed by the processor 110. Execution of such rules or protocols may be prompted by user interaction with the apparatus 102, such as via the I/O device 114.

By way of example, the lead singer 202 may interface with a KTV application of the apparatus 102 via the I/O device 114 to select a song to sing along with, as indicated by the music request 218. Based on the music request 218, the apparatus 102 may prompt the API 210 to execute the appropriate rules or protocols so that a music request 222 may be sent to the music library 212. It should be noted that the music library 212 may be stored locally on the apparatus 102 (e.g., stored in the memory 112) or the music library 212 may be stored externally and accessed by the apparatus 102, such as on one or more servers. When the music request 222 is sent to the music library 212, a music download 224 or music stream may be initiated to transmit the desired song from the music library 212 to the apparatus 102 via the API 210. As a result, the lead singer 202 may now be ready to begin singing along with the desired song using the apparatus 102.

In a similar fashion, the co-singer 204 may interface with a KTV application of the apparatus 104 via the I/O device 122 to select the same song selected by the lead singer 202. To facilitate selection of the same song, the lead singer 202 (e.g., the apparatus 102) may share a token via token sharing 207 with the co-singer 204 (e.g., the apparatus 104) to ensure that both the lead singer 202 and the co-singer have permission to simultaneously select the same song. Based on the token sharing 207, the co-singer may submit a music request 226 that may be similar to the music request 218.

Based on the music request 226, the apparatus 104 may prompt an API 214, which may be similar to the API 210, to execute the appropriate rules or protocols so that a music request 230 may be sent to a music library 216. It should be noted that the music library 216 may be stored locally on the apparatus 104 (e.g., stored in the memory 120) or the music library 216 may be stored externally and accessed by the apparatus 104, such as on one or more servers. In a configuration where the music library 216 is stored externally, the music library 212 and the music library 216 may be a single music library accessed by both the apparatus 102 and the apparatus 104.

When the music request 230 is sent to the music library 216, a music download 232 or music stream may be initiated to transmit the desired song from the music library 216 to the apparatus 104 via the API 214. As a result, the co-singer 204 may also now be ready to being singing along with the desired song using the apparatus 104. That is, the co-singer 204 and the lead singer 202 may simultaneously sing along with the desired song for real-time streaming. It should also be noted that the co-singer 204 may not be present, at which point the lead singer 202 may complete the above steps for a solo performance (e.g., solo singing).

The singing by the lead singer 202 and the co-singer 204 as described above may be transmitted in real-time to the audience 206 via the network 208. The network 208 may be similar to the network 108 described above. To transmit the singing and music in real-time to the audience 206, a lead singer stream 236, which may contain the singing of the lead singer 202 and the music associated with the singing of lead singer 202, may be transmitted from the lead singer 202 (e.g., from the apparatus 102) to the audience 206 (e.g., to the apparatus 106) via the API 210.

Similarly, a co-singer stream 238, which may contain the singing of the co-singer 204 and the music associated with the singing of the co-singer 204, may be transmitted from the co-singer 204 (e.g., from the apparatus 104) to the audience 206 (e.g., to the apparatus 106) via the API 214. The lead singer stream 236 and the co-singer stream 238 may be transmitted to the audience 206 via the network 208.

Additionally, in certain circumstances, a background music (BGM) stream 234 may also be transmitted from the apparatus 102 (e.g., from the lead singer 202) and/or the apparatus 104 (e.g., the co-singer 204) to the apparatus 106 (e.g., the audience 206) to provide background music at times when the lead singer 202 and the co-singer 204 are not actively live-streaming their singing. Thus, based on the above, multiple participants on multiple devices may be in communication via the network 208 to participate in the KTV stream.

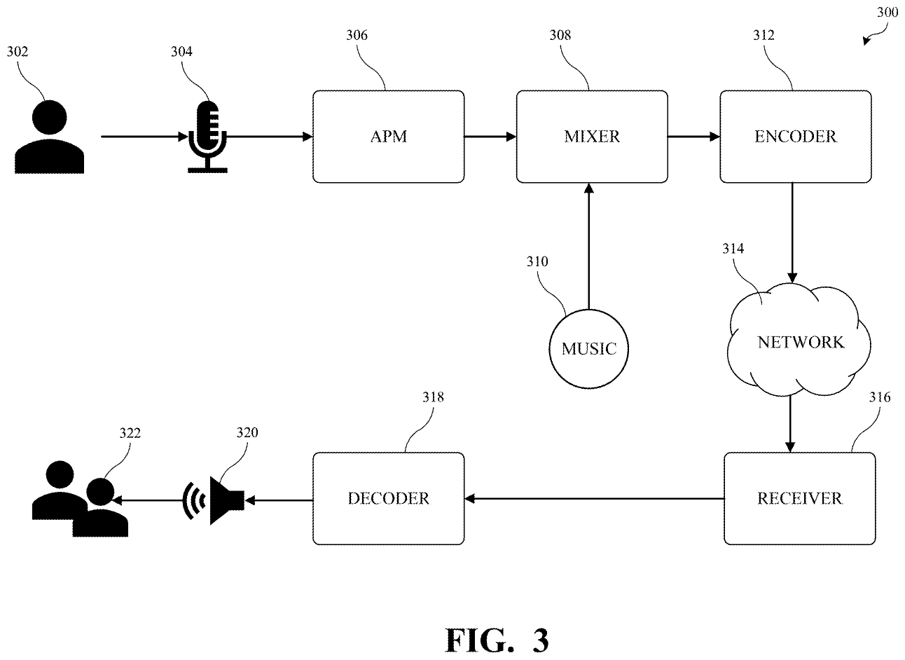

FIG. 3 illustrates an example of a real-time audio communications system 300 for audio recordings. The system 300 may be implemented by a sender and/or a receiver, such as the apparatus 102, the apparatus 104, and the apparatus 106 of FIG. 1. That is, the system 300 may be part of the system 100 of FIG. 1. The system 300 may be configured for real-time audio communications, such as KTV as described with respect to FIG. 2. However, the system 300 may be implemented for any type of real-time audio communications.

As shown in FIG. 3, a user 302 may record their voice (e.g., capture their talking and/or singing as a voice segment) via a recording device 304, such as a microphone. By way of example, the user 302 may utilize the apparatus 102 and the recording device 304 may be the I/O device 114 of the apparatus 102 to record the voice of the user 302. Once the voice of the user 302 is captured (e.g., recorded), the voice (e.g., voice segment) may be processed through the system 300 as audio data, such as one or more audio packets that include all or a portion of the voice (e.g., voice segment) of the user 302 recorded.

For example, the audio data obtained from the user 302 may first be processed through an audio processing module (APM) 306. The APM 306 may be, or may include, hardware and/or software designed to manipulate, enhance, analyze, or a combination thereof the audio data. That is, the APM 306 may alter (e.g., improve) the quality and/or one or more characteristics of the audio data through one or more processing stages within the APM 306. By way of example, the APM 306 may reduce background audio noise, may decrease or eliminate unwanted echoes, may compress and/or decompress the audio data, may adjust the balance of frequencies in the underlying audio signal of the audio data (e.g., an equalization (EQ) module), may complete dynamic range compression (DRC) of the audio data to control a difference between louder and softer parts of the underlying audio signal of the audio data, may correct pitch variations, may apply various audio effects (e.g., reverb, chorus, distortion, other environmental elements, etc.), may complete speech-to-text recognition (e.g., to provide text to the receiver along with the audio transmission), or a combination thereof. By way of example, in the context of KTV, the user 302 may record their singing using the recording device 304 while the user 302 sings along to music. In such a case, the music playing when the user 302 is singing may also be captured by the recording device 304. As a result, the APM 306 may filter out the music so that only the singing of the user 302 remains.

Once the audio data is processed through the APM 306, the audio data may move to a mixer 308. The mixer 308 may combine multiple audio sources together to create a final audio mix that may ultimately be transmitted to an audience. For example, the mixer 308 may be, or may include, one or more modules that may combine the audio data from the user 302 (e.g., singing) with associated music 310 to create a final audio mix that contains both the singing and the associated music 310. By way of example, the user 302 may sing along to a desired song so that the singing is recorded and filtered, at which point the signing may be mixed and aligned properly with the sign for transmission to the audience. After the mixer 308 creates the final audio mix, an encoder 312 may encode the audio data to transmit, via a network 314, to a receiver 316. Encoding by the encoder 312 may be any type of encoding to prepare the final audio mix for transmission, such as the encoding techniques described above.

The network 314 may be similar to the network 108 to establish communication between the encoder 312 and the receiver 316. For example, the encoder 312, the mixer 308, the APM 306, the recording device 304, or a combination thereof may be part of the apparatus 102 and the receiver 316 may be the apparatus 104 and/or the apparatus 106.

Additionally, it should be noted that the APM 306 and/or the mixer 308 may be part of the encoder 312 or may be separate from the encoder 312. Moreover, in certain configurations, the system 300 may be free of the APM 306. For example, the system 300 may include or be part of a neural network, whereby the neural network may provide the functionality of the APM 306. By way of example, the encoder 312 may be a neural network encoder that is configured to provide audio processing similar to the APM 306 as described above.

Once the receiver 316 receives the encoded audio data, a decoder 318 may decode the audio data using any of the decoding techniques described above. The decoder 318 may be part of the receiver 316 (e.g., part of the apparatus 104 and/or the apparatus 106). Once the decoder 318 decodes the audio data, the decoded audio data (e.g., the final audio mix prior to encoding) may be played through a playback device 320, such as a speaker or headphones, so that an audience 322 may listen to the final audio mix. In the above example, the audience 322 may listen to the final audio mix, which may contain the singing of the user 302 and the music 310 associated with the singing.

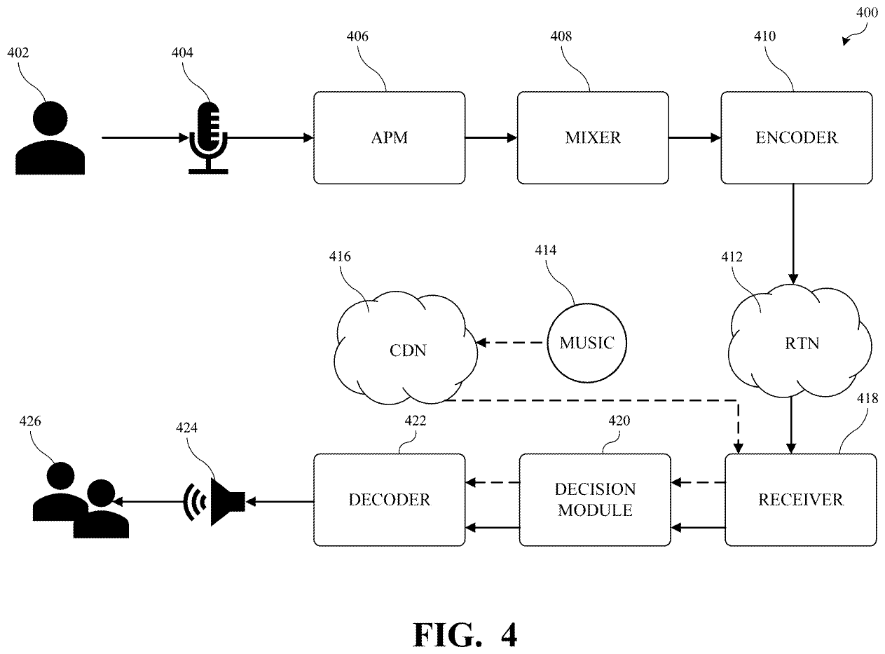

FIG. 4 illustrates another example of a real-time audio communications system 400 for audio recordings. The system 400 may be implemented by a sender and/or a receiver, such as the apparatus 102, the apparatus 104, and the apparatus 106 of FIG. 1. That is, the system 400 may be part of the system 100 of FIG. 1. The system 400 may be configured for real-time audio communications, such as KTV as described with respect to FIGS. 2 and 3. However, the system 400 may be implemented for any type of real-time audio communications.

The system 400 may provide an alternative means for communication audio data when compared to the system 300. In particular, as described further below, the system 400 may provide a means to transmit music or other audio data separately from an audio recording such to decrease the strain on the bandwidth of a network.

To further illustrate the above improvement, a user 402 may record their voice (e.g., capture their talking and/or singing as a voice segment) via a recording device 404. The recording device 404 may be similar to the recording device 304. For example, the user 402 may utilize the apparatus 102 and the recording device 404 may be the I/O device 114 of the apparatus 102 to record the voice of the user 402. Once the voice of the user 402 is captured (e.g., recorded), the voice may be processed through the system 400 as audio data, such as one or more audio packets that include all or a portion of the voice of the user 402 recorded.

For example, the audio data obtained from the user 402 may first be processed through an audio processing module (APM) 406. The APM 406 may be similar to the APM 306 of FIG. 3. That is, the APM 406 may alter (e.g., improve) the quality and/or one or more characteristics of the audio data through one or more processing stages within the APM 406. For example, the APM 406 may filter out background noise (e.g., background music) from the voice recorded by the recording device 404.

Once the audio data is processed through the APM 406, the audio data may move to a mixer 408, which may be similar to the mixer 308 of FIG. 3. However, while the mixer 308 mixed the voice recorded by the user 302 with the music 310, such the mixer 408 may not complete such mixing with respect to the voice recorded by the user 402. That is, the mixer 408 may operate similar to the mixer 308 yet be free of mixing the voice recorded by the user 402 with the associated music. For example, the mixer 408 may combine one or more different audio signals to prepare for transmission of the audio data, whereby the different audio signals may originate from the voice recorded by the user 402 or may be established at the APM 406. As a result, the mixer 408 may create an intermediate audio mix.

After the mixer 408 creates the intermediate audio mix, an encoder 410 may encode the audio data to transmit, via a real-time network (RTN) 412, to a receiver 418. Encoding by the encoder 410 may be any type of encoding to prepare the intermediate audio mix for transmission, such as the encoding techniques described above.

The RTN 412 may be similar to the network 314 and the network 108 to establish communication between the encoder 410 and the receiver 418. For example, the encoder 410, the mixer 408, the APM 406, the recording device 404, or a combination thereof may be part of the apparatus 102 and the receiver 418 may be the apparatus 104 and/or the apparatus 106. In such a case, the intermediate audio mix may be transmitted through the RTN 412 in real-time from the encoder 410 to the receiver 418.

In addition to receiving the encoded audio data (e.g., the encoded intermediate audio mix), the receiver 418 may also receive associated music 414 through a content delivery network (CDN) 416. The CDN 416 may be any network that is separate from the RTN 412 such that the associated music 414 may be transmitted or otherwise accessed by the receiver 418 independently of transmitting the audio data from the encoder 410. That is, the receiver 418 may receive the associated music 414 that may be associated with the voice recorded by the user 402 independently of the voice recorded by the user 402. In such a case, the associated music 414 need not be transmitted over the RTN 412 and instead may be transmitted to the receiver 418 via the CDN 416. That is, the associated music 414 may be transmitted to the receiver 418 or otherwise accessed by the receiver 418 in a manner that does not require bandwidth of the RTN 412. As a result, the system 400 may decrease the overall bandwidth utilization of the RTN 412, thereby decreasing audio packet loss, jitter, and other similar types of degradation to the audio data received by the receiver 418.

It should be noted that the associated music 414 may be transmitted to the receiver 418 before transmission of the audio data (e.g., the recorded voice) by the encoder 410, may be transmitted during transmission of the audio data from the encoder 410, or may be transmitted to the receiver 418 after transmission of the audio data by the encoder 410. For example, the associated music 414 may be transmitted, via the CDN 416 (e.g., from one or more servers that may contain a music library), to the receiver 418 prior to transmission of the audio data from the encoder 410. In such a case, the associated music 414 may then be locally stored on the receiver 418 and locally accessed when needed.

By way of example, the system 400 (e.g., the receiver 418) may include a decision module 420 that may be, or may include, hardware and/or software designed to manipulate, enhance, analyze, or a combination thereof the audio data received from the encoder 410, as indicated by a solid line, and the associated music 414, as indicated by a dashed line. The decision module 420 may include one or more processes and/or one or more rules to evaluate the audio data from the encoder 410 and the associated music 414.

For example, the voice recorded by the recording device 404 may be associated with a timestamp. Such association may be completed at the APM 406, the mixer 408, or the encoder 410. In such a case, the voice recorded—or audio packets containing all or a portion of the voice recorded—may be associated with a respective timestamp to indicate a point in time for each portion of the voice recorded. In such a case, the voice recorded and the timestamp may be encoded by the encoder 410 and transmitted to the receiver 418 via the RTN 412. As a result, the decision module 420 may align the voice recorded with the associated music 414 based upon the timestamp of the voice recorded.

For example, the timestamp associated with the voice recorded may indicate a relative position shift from a beginning of the associated music 414 (e.g., from the beginning of a song the user 402 is singing). As a result, the decision module 420 may align the associated music 414 with the voice recorded based upon the timestamp associated with the voice recorded so that the voice recorded (e.g., the singing) aligns with the appropriate portion of the song. Similarly, the associated music 414 may also include one or more timestamps so that a timestamp of the associated music 414 may be compared to and/or aligned with, the timestamp associated with the voice recorded (e.g., the singing). Thus, the singing and the song may be properly aligned from a time perspective.

It should also be noted that the decision module 420 may be used for additional operations other than aligning the voice recorded with the associated music 414. For example, the decision module 420 may determine any integrity issues of the associated music 414 and/or the voice recorded, such as audio packet data loss. In such a case, the decision module 420 may determine whether the data received from the encoder 410 and the associated music 414 should be processed further (e.g., mixed and/or decoded) or whether additional steps may be needed to fill or resolve any integrity issues (e.g., fill audio packet data loss). For example, the decision module 420 may determine that audio packet data loss has occurred, at which point the decision module 420 may resolve the audio packet data loss by incorporating a locally stored audio data packet that may take the place of the lost audio data packet, such as a portion of the associated music 414.

Once the audio data is evaluated by the decision module 420, a decoder 422 may decode the audio data using any of the decoding techniques described above. The decoder 422 may be part of the receiver 418 (e.g., part of the apparatus 104 and/or the apparatus 106). Additionally, the decoder 422 may also be or include a mixer similar to the mixer 408, whereby the decoder 422 may combine the associated music 414 with the voice recorded (e.g., the voice data (i.e., segment) transmitted from the encoder 410) to create a final audio mix. Such mixing may be based on the timestamps as discussed above.

Once the audio data is decoded by the decoder 422 and/or mixed, the decoded audio data (e.g., the final audio mix prior the includes both the voice recorded and the associated music 414) may be played through a playback device 424, such as a speaker or headphones, so that an audience 426 may listen to the final audio mix. In the above example, the audience 426 may listen to the final audio mix, which may contain the singing of the user 402 and the music 414 associated with the singing.

FIG. 5 is a flowchart of an example of a technique 500 for real-time audio communication. The technique 500 may be implemented by a sender, such as the apparatus 102 of FIG. 1, and/or a receiver, such as the apparatus 104 and the apparatus 106 of FIG. 1. The technique 500 may be implemented as software modules stored in the memory 112, the memory 120, and/or the memory 128 of FIG. 1 as instructions and/or data executable by the processor 110, the processor 118, and/or the processor 126 of FIG. 1, respectively. For another example, the technique 500 may be implemented in hardware as a specialized chip storing instructions executable by the specialized chip.

The technique 500 may be performed by the sender and/or the receiver at each time step. For example, if the sender is transmitting audio data for playback at a rate of one audio packet every 33 milliseconds, then the technique 500 may be performed once approximately ever 33 milliseconds. Similarly, the technique 500 may be performed by the sender and/or the receiver based upon a defined time duration. For example, the technique 500 may be performed by the sender and/or the receiver once every X time steps, where X may be defined as a set number of time steps. Portions of the technique 500 performed by the sender may be communicated to the receiver through a network, such as the network 108. Similarly, portions of the technique 500 performed by the receiver may be communicated to the sender through a network, such as the network 108.

As discussed above, the sender may be configured to record audio signals, such as a voice of a user. Such audio recording may be completed at 502 using a recording device, such as a microphone, which may be similar to the recording device 404 of FIG. 4. As discussed above, the recorded audio may be singing of a user that may be associated with a particular song or music.

Once audio is recorded at 502, the audio data may be processed at an audio processing module (APM) at 504. The APM may be similar to the APM 406 of FIG. 4. That is, the APM may process the audio data at 504 to eliminate background noise or otherwise improve the quality of the singing recorded. Additionally, a timestamp may be associated with the audio data at 504 so that the singing recorded may be properly aligned with the associated music.

Once the audio data is processed at 504, the audio data (e.g., the singing/voice segment recorded) may be encoded at 506 using any of the encoding techniques described above. After encoding at 506, the audio data (e.g., the singing/voice segment recorded) may be transmitted to a receiver at 508. In such a case, the sender/encoder may be the apparatus 102 and the receiver may be the apparatus 104 and/or the apparatus 106. The encoded audio data may be transmitted via a network, such as the real-time network (RTN) 412 of FIG. 4. Additionally, it should be noted that additional steps may be taken prior to encoding the audio data at 506. For example, the audio data may also be processed through a mixer similar to the mixer 408 of FIG. 4.

Before, during, or after transmission of the audio data at 508, the associated music (e.g., song) may be transmitted at 510. The associated music may also be transmitted to the receiver so that both the associated music and the audio data from the encoder are accessible by the receiver. However, as described above, the associated music may be transmitted to the receiver separately from the audio data over a separate network connection, such as via the content delivery network (CDN) 416, to decrease bandwidth needed on the RTN 412 being used to transmit the singing/voice recorded.

After transmission of the audio data from the encoder (e.g., the sender) and transmission of the associated music, the receiver may process the audio data and the associated music at 512. For example, the receiver may include a decision module similar to the decision module 420 of FIG. 4. In such a case, the receiver may align the voice/singing recorded with the associated music, such as based on a timestamp, so that the voice/singing recorded and the associated music may correctly align for audio playback for an audience. However, processing at 512 is not limited to any one process and may include any manipulation and/or alteration of the audio data and/or the associated music.

After processing at 512, the audio data (e.g., the voice/singing recorded) and the associated music may be decoded at 514 using any of the decoding techniques described above. Decoding at 514 may be done by a decoder similar to the decoder 422. For example, decoding at 514 may also include mixing the associated music with the voice/singing recorded to create a final audio mix. After decoding is completed at 514, the audio data and associated music (e.g., the final audio mix) may be played using one or more playback devices at 516, such as a speaker or headphones. Thus, based on the technique 500, the associated music and the recorded singing may be transmitted to the receiver separately yet may align for proper- and improved-audio playback for an audience while also decreasing the strain on the real-time network (RTN) being used to transmit the recorded singing.

FIG. 6 is a flowchart of an example of a technique 600 for real-time audio communication, such as a method for real-time audio transmission of a voice segment of a speaker. The technique 600 may be implemented by a sender, such as the apparatus 102 of FIG. 1, and/or a receiver, such as the apparatus 104 and the apparatus 106 of FIG. 1. The technique 600 may be implemented as software modules stored in the memory 112, the memory 120, and/or the memory 128 of FIG. 1 as instructions and/or data executable by the processor 110, the processor 118, and/or the processor 126 of FIG. 1, respectively. For another example, the technique 600 may be implemented in hardware as a specialized chip storing instructions executable by the specialized chip.

At 602, the voice segment of the speaker may be obtained by an encoder (e.g., the sender). For example, the encoder may include a recording device, such as a microphone, which may record a voice of the speaker (e.g., singing by the speaker). At 604, a reference sample associate with the voice segment of the speaker may be obtained by one or more servers in communication with the encoder at 604. The reference sample may be, for example, music associated with singing of the speaker that is recorded at 602. The reference sample may be the associated music 414 of FIG. 4. Additionally, at 604, the reference sample may be stored locally on a decoder (e.g., the receiver) that is in communication with the encoder.

Additionally, a timestamp associated with the voice of the speaker obtained at 602 may be established at 606, whereby the timestamp is established relative to the reference sample. After establishing the timestamp at 606, encoding may be completed at 608. Encoding may be completed by the encoder (e.g., the sender) to encode an audio packet that includes the voice segment of the speaker (e.g., singing recording) and the timestamp associated with the voice segment of the speaker.

The audio packet may then be transmitted, in real time, at 610 to a decoder (e.g., the receiver). The voice segment of the speaker (e.g., the singing recording) in the audio packet may be combined with the reference sample (e.g., the associated music) during decoding. Such combining may be based upon the timestamp associated with the voice segment of the speaker.

As described above, a person skilled in the art will note that all or a portion of aspects of the disclosure described herein can be implemented using a general-purpose computer/processor with a computer program that, when executed, carries out any of the respective techniques, algorithms, and/or instructions described herein. In addition, or alternatively, for example, a special-purpose computer/processor, which can contain specialized hardware for carrying out any of the techniques, algorithms, or instructions described herein, can be utilized.

The implementations of computing devices (i.e., apparatuses) as described herein (and the algorithms, methods, instructions, etc., stored thereon and/or executed thereby) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors or any other suitable circuit. In the claims, the term “processor” should be understood as encompassing any of the foregoing, either singly or in combination.

The aspects herein can be described in terms of functional block components and various processing operations. The disclosed processes and sequences may be performed alone or in any combination. Functional blocks can be realized by any number of hardware and/or software components that perform the specified functions. For example, the described aspects can employ various integrated circuit components, for example, memory elements, processing elements, logic elements, look-up tables, and the like, which can carry out a variety of functions under the control of one or more microprocessors or other control devices. Similarly, where the elements of the described aspects are implemented using software programming or software elements, the disclosure can be implemented with any programming or scripting languages, such as C, C++, Java, assembler, or the like, with the various algorithms being implemented with any combination of data structures, objects, processes, routines, or other programming elements. Functional aspects can be implemented in algorithms that execute on one or more processors. Furthermore, the aspects of the disclosure could employ any number of conventional techniques for electronics configuration, signal processing and/or control, data processing, and the like. The words “mechanism” and “element” are used broadly and are not limited to mechanical or physical implementations or aspects, but can include software routines in conjunction with processors, etc.

Implementations or portions of implementations of the above disclosure can take the form of a computer program product accessible from, for example, a computer-usable or computer-readable medium. A computer-usable or computer-readable medium can be any device that can, for example, tangibly contain, store, communicate, or transport a program or data structure for use by or in connection with any processor. The medium can be, for example, an electronic, magnetic, optical, electromagnetic, or semiconductor device. Other suitable mediums are also available. Such computer-usable or computer-readable media can be referred to as non-transitory memory or media and can include RAM or other volatile memory or storage devices that can change over time. A memory of an apparatus described herein, unless otherwise specified, does not have to be physically contained in the apparatus, but is one that can be accessed remotely by the apparatus, and does not have to be contiguous with other memory that might be physically contained in the apparatus.

Any of the individual or combined functions described herein as being performed as examples of the disclosure can be implemented using machine-readable instructions in the form of code for operation of any or any combination of the aforementioned hardware. The computational codes can be implemented in the form of one or more modules by which individual or combined functions can be performed as a computational tool, the input and output data of each module being passed to/from one or more further modules during operation of the methods and systems described herein.

The terms “signal” and “data” are used interchangeably herein. Further, portions of the computing devices do not necessarily have to be implemented in the same manner. Information, data, and signals can be represented using a variety of different technologies and techniques. For example, any data, instructions, commands, information, signals, bits, symbols, and chips referenced herein can be represented by voltages, currents, electromagnetic waves, magnetic fields or particles, optical fields or particles, other items, or a combination of the foregoing.

The word “example” is used herein to mean serving as an example, instance, or illustration. Any aspect or design described herein as “example” is not necessarily to be construed as being preferred or advantageous over other aspects or designs. Rather, use of the word “example” is intended to present concepts in a concrete fashion. Moreover, use of the term “an aspect” or “one aspect” throughout this disclosure is not intended to mean the same aspect or implementation unless described as such.

As used in this disclosure, the term “or” is intended to mean an inclusive “or” rather than an exclusive “or” for the two or more elements it conjoins. That is, unless specified otherwise or clearly indicated otherwise by the context, “X includes A or B” is intended to mean any of the natural inclusive permutations thereof. In other words, if X includes A; X includes B; or X includes both A and B, then “X includes A or B” is satisfied under any of the foregoing instances. Similarly, “X includes one of A and B” is intended to be used as an equivalent of “X includes A or B.” The term “and/or” as used in this disclosure is intended to mean an “and” or an inclusive “or.” That is, unless specified otherwise or clearly indicated otherwise by the context, “X includes A, B, and/or C” is intended to mean that X can include any combinations of A, B, and C. In other words, if X includes A; X includes B; X includes C; X includes both A and B; X includes both B and C; X includes both A and C; or X includes all of A, B, and C, then “X includes A, B, and/or C” is satisfied under any of the foregoing instances. Similarly, “X includes at least one of A, B, and C” is intended to be used as an equivalent of “X includes A, B, and/or C.”

The use of “including” or “having” and variations thereof herein is meant to encompass the items listed thereafter and equivalents thereof as well as additional items. Depending on the context, the word “if” as used herein can be interpreted as “when,” “while,” or “in response to.”

The use of the terms “a” and “an” and “the” and similar referents in the context of describing the disclosure (especially in the context of the following claims) should be construed to cover both the singular and the plural. Furthermore, unless otherwise indicated herein, recitation of ranges of values herein is intended merely to serve as a shorthand method of referring individually to each separate value falling within the range, and each separate value is incorporated into the specification as if it were individually recited herein. Finally, the operations of all methods described herein are performable in any suitable order unless otherwise indicated herein or otherwise clearly contradicted by the context. The use of any and all examples, or language indicating that an example is being described (e.g., “such as”), provided herein is intended merely to better illuminate the disclosure and does not pose a limitation on the scope of the disclosure unless otherwise claimed.

This specification has been set forth with various headings and subheadings. These are included to enhance readability and ease the process of finding and referencing material in the specification. These headings and subheadings are not intended, and should not be used, to affect the interpretation of the claims or limit their scope in any way. The particular implementations shown and described herein are illustrative examples of the disclosure and are not intended to otherwise limit the scope of the disclosure in any way.

All references, including publications, patent applications, and patents, cited herein are hereby incorporated by reference to the same extent as if each reference were individually and specifically indicated as incorporated by reference and were set forth in its entirety herein.

While the disclosure has been described in connection with certain embodiments and implementations, it is to be understood that the disclosure is not to be limited to the disclosed implementations but, on the contrary, is intended to cover various modifications and equivalent arrangements included within the scope of the appended claims, which scope is to be accorded the broadest interpretation as is permitted under the law so as to encompass all such modifications and equivalent arrangements.

What is claimed is:

1. A method of audio transmission of a voice segment of a speaker, comprising:
receiving, via an encoder, the voice segment of the speaker;
obtaining, from one or more servers in communication with the encoder, a reference sample associated with the voice segment of the speaker;
establishing a timestamp associated with the voice segment of the speaker relative to the reference sample;
encoding, via the encoder, an audio packet that includes the voice segment of the speaker and the timestamp associated with the voice segment of the speaker; and
transmitting, in real-time, the audio packet to a decoder, wherein the voice segment of the speaker in the audio packet is to be combined with the reference sample based on the timestamp associated with the voice segment of the speaker during decoding.

2. The method of claim 1, further comprising:
transmitting, to the decoder from the one or more servers via a content delivery network, the reference sample associated with the voice segment of the speaker.

3. The method of claim 2, wherein the reference sample is transmitted to the decoder via the content delivery network prior to transmitting the audio packet to the decoder, and the audio packet is transmitted to the decoder in real-time.

4. The method of claim 3, wherein the reference sample is also transmitted to the encoder.

5. The method of claim 1, wherein the reference sample is a music packet, and the voice segment of the speaker is data representing singing of the speaker that is associated with the music packet.

6. The method of claim 1, wherein combining the voice segment of the speaker with the reference sample based upon the timestamp associated with the voice segment of the speaker includes:
aligning the voice segment of the speaker with the reference sample based upon the timestamp as a relative time shift from a beginning of the reference sample.

7. The method of claim 1, wherein combining the voice segment of the speaker with the reference sample based upon the timestamp associated with the voice segment of the speaker includes:
aligning the timestamp associated with the voice segment of the speaker and a timestamp associated with the reference sample, wherein a value of the timestamp associated with the voice segment of the speaker is equal to a value of the timestamp associated with the reference sample.

8. The method of claim 1, further comprising:
filtering the voice segment of the speaker to eliminate background audio obtained by the encoder.

9. A system for audio transmission of the voice segment of the speaker, comprising:
a non-transitory memory; and
at least one processor configured to execute instructions stored in the non-transitory memory to perform operations according to the method of claim 1.

10. The system of claim 9, wherein the at least one processor is further configured to execute instructions stored in the non-transitory memory to:
transmit, to the decoder from the one or more servers via a content delivery network, the reference sample associated with the voice segment of the speaker.

11. The system of claim 10, wherein the reference sample is transmitted to the decoder via the content delivery network prior to transmitting the audio packet to the decoder, and the audio packet is configured to be transmitted to the decoder via real-time communication.

12. The system of claim 9, wherein combining the voice segment of the speaker with the reference sample based upon the timestamp associated with the voice segment of the speaker includes:
aligning the voice segment of the speaker with the reference sample based upon the timestamp as a relative time shift from a beginning of the reference sample.

13. The system of claim 9, wherein combining the voice segment of the speaker with the reference sample based upon the timestamp associated with the voice segment of the speaker includes:
aligning the timestamp associated with the voice segment of the speaker and a timestamp associated with the reference sample, wherein a value of the timestamp associated with the voice segment of the speaker is equal to a value of the timestamp associated with the reference sample.

14. The system of claim 9, wherein the at least one processor is further configured to execute instructions stored in the non-transitory memory to:
filter the voice segment of the speaker to eliminate background audio obtained by the encoder.

15. A non-transitory computer-readable storage medium configured to store computer programs for audio transmission of a voice segment of a speaker, the computer programs comprising instructions executable by at least one processor to perform operations according to the method of claim 1.

16. A method of audio transmission of a voice segment of a speaker, comprising:
obtaining, from one or more servers via a content delivery network, a reference sample associated with the voice segment;
receiving, from an encoder via real-time, an audio packet that includes the voice segment of the speaker and a timestamp associated with the voice segment of the speaker relative to the reference sample; and
responsive to receiving the audio packet from the encoder, combining the voice segment of the speaker with the reference sample based upon the timestamp associated with the voice segment of the speaker.

17. The method of claim 16, wherein the voice segment of the speaker is to be obtained by the encoder in real-time.

18. The method of claim 16, wherein the reference sample is also to be transmitted to the encoder from the one or more servers.

19. The method of claim 16, wherein combining the voice segment of the speaker with the reference sample based upon the timestamp associated with the voice segment of the speaker includes:
aligning the voice segment of the speaker with the reference sample based upon the timestamp as a relative time shift from a beginning of the reference sample.

20. The method of claim 16, wherein combining the voice segment of the speaker with the reference sample based upon the timestamp associated with the voice segment of the speaker include:
aligning the timestamp associated with the voice segment of the speaker and a timestamp associated with the reference sample.

21. The method of claim 16, further comprising:
determining whether the audio packet transmitted by the encoder is lost; and
responsive to determining that the audio packet transmitted by the encoder is lost, replacing the audio packet with a replacement audio packet that is included in the reference sample.
